(19) United States
(12) Patent Application Publication
(10) Pub. No.: US 2025/0129228 A1
(43) Pub. Date: Apr. 24, 2025

(54) FREE-STANDING WET LOW-DENSITY CELLULOSE FIBRE FOAM

(71) Applicant: Stora Enso OYJ, Helsinki (FI)

(72) Inventors: Oruç Köklükaya, Stockholm (SE); Daniel Hult Torron, Täby (SE); Maryam Ghanadpour, Solna (SE)

(73) Assignee: Stora Enso OYJ, Helsinki (FI)

(21) Appl. No.: 18/722,216

(22) PCT Filed: Dec. 22, 2022
(86) PCT No.: PCT/IB2022/062664

§ 371 Date: Jun. 20, 2024

(30) Foreign Application Priority Data
Dec. 22, 2021 (SE) 2151606-7

(51) Int. Cl. C08J 9/236; C08J 9/00

(52) U.S. Cl. CPC C08J 9/236; C08J 9/0085; C08J 2201/0504; C08J 2301/02

(57) ABSTRACT

The present invention relates to a foam composition comprising cellulose fibres, a water-soluble thickener, and surfactants. The foam composition can be used for preparing a foam that can be dried without constraints to form three-dimensional objects.

### FIELD OF THE INVENTION

The present invention relates to a foam composition comprising cellulose fibres, a water-soluble thickener, and surfactants. The foam composition can be used for preparing a foam that can be dried without constraints to form three-dimensional objects.

### TECHNICAL BACKGROUND

In our everyday life, macroporous and microporous materials are used in various forms and compositions. These materials have commonly been based on petroleum-based polymers, but due to the increased awareness of the need to use renewable materials, there is an endeavor to replace petroleum-based polymers with polymers from renewable resources. There are different techniques used today to prepare a cellulose fibre foam material. In WO2020011587 A1 a porous material of cellulose fibres and gluten is prepared by aerating a cellulose fibre paste comprising cellulose fibres and gluten and depositing the wet foam in a mould, followed by drying, to obtain a dried porous material with the shape of the mould and a homogeneous fibre network through the whole bulk. In WO2015036659 A1 a wet fibrous foam is made by mixing fibres, additives, and surfactants in water to generate a liquid-air foam that is drained to a specific thickness, using either mechanical work or pressure. The moist fibrous foam is then consolidated using a mould through conventional drying techniques.

A composition forming a foam structure comprising fibrous and fibrillated materials, a cross-linker and a surfactant, for the production of a lightweight paperboard is presented in US2020240080 A1. An aerated fibrous slurry composition comprising a fibrous material, a foaming agent, a stabilizer, water, and a volume of gas is shown in U.S. Pat. No. 5,612,385 A. The aerated fibrous slurry can be dried into a resilient foam.

An aqueous foam composition comprising fibres, a binder system including a thickening agent, and a foaming agent is disclosed in U.S. Pat. No. 4,613,627 A. The foam can be casted or moulded into desired shapes. US2015114581 A1 presents a foam comprising water and a surfactant, wherein microfibrillated cellulose (MFC) and a pulp of a greater fibre length have been incorporated. The foam is used in the preparation of a fibrous web of paper or board by applying the foam onto a forming fabric, dewatering, and drying.

In foam-forming based on conventional paper making techniques, the foam needs to be drained onto a screen or a forming fabric. In this case, there are limits to the shape and size of the material as it will level during draining. In order for efficient draining to occur, the viscosity of the liquid need to be kept rather low for efficient extraction of water. Any soluble binder would thus be limited to low concentrations and should be able to retain on the fibre to avoid excessive losses. Therefore, draining limits the number of additives that could be used in this type of process. The strength of thick low-density foam-formed paper is primarily controlled by the bulk of the material. The primary means of improving strength here is to increase density, with some limited control on fibre orientation, based on draining characteristics.

Higher dry-content techniques such as foams made from large quantities of protein-based foaming-agents (WO2020011587 A1 for example), hinders recyclability due to large fractions of the material not being water soluble or easily washed out from the product. Further, the wet foam stability is not enough for the foam to be dried without a mould because protein particles start to agglomerate and bubbles coalesce, leading to gradual collapse of foam in the wet state. This fact makes it a non-suitable candidate for free-standing wet foam deposition.

Thus, there is still need for alternative foam compositions that are recyclable, dimensionally stable already in the wet state, and that can be produced with more efficient processes.

### SUMMARY OF THE INVENTION

It is an object of the present invention to provide a free-standing wet low-density cellulose fibre foam composition that can be dried without constraints to form three-dimensional objects.

In a first aspect the present invention relates to a foam composition comprising:
a) from 71-95 wt % cellulose fibres, as calculated on the total weight of solid content of the composition,
b) from 4-24 wt % of a water-soluble thickener, as calculated on the total weight of solid content of the composition, and
c) at least two surfactants.

The foam composition according to the present invention may be a wet foam composition having a total solid content ranging from 12-40 wt %, as calculated on the total weight of the wet composition. The foam composition according to the present invention may also be a dry foam, such as having a solid content ranging from 95-100 wt %, as calculated on the total weight of the composition.

In a further aspect, the present invention relates to a method for the preparation of a foam having the composition according to the first aspect, wherein the method is comprising
a) disintegrating cellulose fibres in water to obtain a slurry of cellulose fibres;
b) adding a water-soluble thickener to the slurry obtained in a) to obtain a mixture of thickener and cellulose fibres in water;
c) adding at least two surfactants to the mixture obtained in b) to obtain a fibre suspension; and
d) aerating the fibre suspension obtained in c) to obtain a wet foam, wherein the wet foam comprises 10-38 wt % cellulose fibres, 0.5-10 wt % of the water-soluble thickener, and 0.1-2 wt % surfactants, as calculated on the total weight of the wet foam, and wherein the foam has a density of from 140-500 kg/m³ and a yield stress of at least 80 Pa.

### BRIEF DESCRIPTION OF THE DRAWINGS

FIG. 1a-b show the yield stress of wet foams having different solid contents. FIG. 1a shows the yield stress as a function of the wet density of the wet foam composition, for wet foams prepared so as to have different solid contents. The slope of the linear graphs obtained in FIG. 1a are plotted against the solid content of the wet foam in FIG. 1b. The solid line in the figures represents the yield line, i.e. the gravitational stress of a 5 cm thick sample.

### DETAILED DESCRIPTION OF THE INVENTION

In a first aspect the present invention relates to a foam composition comprising:
a) from 71-95 wt % cellulose fibres, as calculated on the total weight of solid content of the composition,
b) from 4-24 wt % of a water-soluble thickener, as calculated on the total weight of solid content of the composition, and
c) at least two surfactants.

The foam composition according to the present invention may be a wet foam composition having a total solid content ranging from 12-40 wt %, or from 12-25 wt %, or from 13-20 wt %, as calculated on the total weight of the wet composition. The density of such wet foam composition may be from 140-500 kg/m³, or from 140-400 kg/m³. In some embodiments, the yield stress of such wet foam composition may be at least 80 Pa, or at least 100 Pa, or at least 150 Pa, or from 80 to 500 Pa, or from 100 to 500 Pa, or from 150 to 500 Pa. In some embodiments, the yield stress of the wet foam composition may be from 20 to 200 Pa, or from 50 to 150 Pa, or from 70 to 150 Pa.

The foam composition according to the present invention may also be a dry foam, such as having a solid content ranging from 95-100 wt %, or 98-100 wt %, as calculated on the total weight of the composition. The foam composition according to the present invention may be a dry foam having a density from 10-60 kg/m³. In some embodiments, the foam composition may be a dry foam having a density from 10-80 kg/m³.

The present invention also relates to the use of the foam composition in a solid foam.

In a further aspect, the present invention relates to a method for the preparation of a foam having the composition according to the first aspect, wherein the method is comprising
a) disintegrating cellulose fibres in water to obtain a slurry of cellulose fibres;
b) adding a water-soluble thickener to the slurry obtained in a) to obtain a mixture of thickener and cellulose fibres in water;
c) adding at least two surfactants to the mixture obtained in b) to obtain a fibre suspension; and
d) aerating the fibre suspension obtained in c) to obtain a wet foam, wherein the wet foam comprises 10-38 wt % cellulose fibres, 0.5-10 wt % of the water-soluble thickener, and 0.1-2 wt % surfactants, as calculated on the total weight of the wet foam, and wherein the foam has a density of from 140-500 kg/m³ and a yield stress of at least 80 Pa.

The term “foam”, as used herein, refers to a substance made by trapping air or gas bubbles inside a solid or liquid. Typically, the volume of gas is much larger than that of the liquid or solid, with thin films separating gas pockets. Three requirements must be met in order for foam to form. Mechanical work is needed to increase the surface area. This can occur by agitation, dispersing a large volume of gas into a liquid, or injecting a gas into a liquid. The second requirement is that a foam forming agent, typically an amphiphilic substance, a surfactant or surface-active component, must be present to decrease surface tension. Finally, the foam must form more quickly than it breaks down.

In the present invention, the term “foam” refers to a cellulose foam having a foam composition according to the first aspect, and that may be obtained by the method according to the further aspect. The foam according to the present invention thus refers to a cellulose foam comprising cellulose, a water-soluble thickener, and at least two surfactants. The main component of the foam is cellulose, such that cellulose constitutes at least 70 wt % of the solid content of the cellulose foam, or from 71-95 wt % of the solid content of the cellulose foam. Cellulose is in the form of fibres, and the foam can thus also be defined to be a fibrous foam or a cellulose fibre foam. The foam may be wet or dry.

The term “wet foam”, or “wet foam composition”, as used herein, refers to a wet foam comprising cellulose, a water-soluble thickener, and at least two surfactants. Gas bubbles are present within the wet foam. The wet foam is freestanding and behaves as a viscoelastic solid. This means that the wet foam has both viscous and elastic properties. The wet foam will behave as a solid, and thus be freestanding, unless a large enough force is applied so that it starts to flow and instead behave as a viscous material. Depending on the magnitude and timescale of any applied shear stress, the wet foam can show a predominantly viscous or elastic behaviour.

The term “dry foam”, or “dry foam composition”, as used herein, refers to a dry and solid porous cellulose material that has been formed from a wet cellulose foam, i.e. a foam formed material. During the drying process, a closed wet cellulose foam is transformed into an open dry cellulose foam. The network of cellulose fibres is prevented from collapsing during drying. The dry foam will as a result have a shape that to a large extent corresponds to that of the wet foam. The solid content of the dry foam is at least 95 wt % as calculated based on the total weight of the dry foam. The shape and density of the dry foam is retained also in a non-confined state. The dry foam has an open cell structure, allowing air to occupy the pores within the foam. The dry foam can also be described as a solid foam, a porous material or a low-density material.

As used herein “yield stress” denotes the amount of stress required to initiate continuous motion in the form of Newtonian flow in a complex fluid, such as a suspension, wet foam, or a paste. The yield stress can be measured with a viscometer fitted with a vane-geometry at a controlled shear-rate where a constant rotational speed is applied to the vane and the resulting torque is measured as a function of time. The rotational speed is usually set between 0.1 and 8 rpm. The yield stress refers to the stress required to cause continuous rotation of the vane.

The foam according to the present invention may comprise from 71-95 wt %, or 75-95 wt %, cellulose fibres, as calculated on the total weight of solid content in the composition. The cellulose fibres may be selected from wood pulp; regenerated cellulose fibres; and plant fibres, such as fibres from bamboo, cotton, hemp, flax, and jute. Preferably, the cellulose fibres are selected from wood pulp, such as softwood Kraft bleached pulp, hardwood pulp, chemical-thermomechanical pulp, and from dissolving pulp, or a combination of one or more of these. More preferably the cellulose pulp fibres are from softwood pulp, chemical-thermomechanical pulp, or dissolving pulp. Most preferably the cellulose pulp fibres are from softwood pulp, such as softwood Kraft bleached pulp. The slurry of cellulose fibres obtained in the first step a) of the method according to the present invention may comprise 10-30 wt %, or 12-25 wt %, cellulose fibres, as calculated on the total weight of the slurry.

The water-soluble thickener increases the viscosity of the liquid phase in the foam. By using a water-soluble thickener, the viscosity of the nanometer sized liquid films between bubbles is increased, further stabilizing the system through viscous damping. Non-water-soluble thickeners, such as microfibrillated cellulose and other particle-based thickeners, would not fit inside the thin liquid films between the bubbles in the densely packed foam. The water-soluble thickener increases the shear forces during mechanical agitation whilst also acting as an anti-flocculant for the solid fibre particles. Furthermore, by increasing the viscosity the diffusion rate of the system is minimized, thus slowing down the rate of bubble coalescence. The water-soluble thickener enables incorporation of enough air to generate a densely packed foam having a yield stress that is high enough to sustain the weight of the foam at up to 5 or 10 cm thickness. Another aspect of setting a high viscosity is to maintain an even concentration throughout the foam structure, by slowing down liquid drainage.

The charge density of the thickener also plays an important role on the wet foam stability due to the ionic interaction between the different components of the system. A thickener with a low charge density causes the cellulose fibres to stick to both the carrying board and to each other and also increases the reject rate, which complicates the recycling of the material. The higher the charge density of the thickener, the higher its solubility.

Since the cellulose fibres are mixed in high concentrations a drainage step is not needed, which enables the use of a water-soluble bio-based thickener in high concentrations. The thickener may thus be a water-soluble thickener. A water-soluble thickener is also an advantage when recycling the foam composition, for example in regular paper recycling streams. The thickener may be present in an amount of from 4-24 wt %, or from 5-20 wt %, as calculated on the total weight of solid content of the composition. The thickener may have a molecular weight of from 80 000-250 000 g/mol, or from 83 000-197 000 g/mol. Exemplary water-soluble thickeners are selected from carboxy methyl cellulose (CMC), methyl cellulose (MC), hydroxyethyl cellulose (HEC), ethyl hydroxyethyl cellulose (EHEC), methyl hydroxypropyl cellulose (MHPC), starch, xanthan, guar gum, and xyloglucan, or mixtures thereof. The thickener may be added to the slurry obtained in step (a) as a solution, such as a solution comprising 4-12 wt %, or 4-6 wt % of the thickener. Preferably, the solution comprising the thickener is an aqueous solution.

The foam according to the present invention comprises a mixture of at least two surfactants. One of the at least two surfactants is preferably a fast-acting surfactant that quickly settle at the air-water interphase during mechanical agitation, which contributes to the formation of a foam with a high density and a high viscosity and thus enables a free-standing foam. A suitable surfactant for this purpose is an anionic surfactant, preferably a low-molecular weight anionic surfactant. The anionic surfactant may have an apparent pka of from 3.2 to 3.8, preferably from 3.4 to 3.6, or an apparent pKa of 3.5 in a solution having a pH of from 7 to 9, preferably a pH of 8. The low-molecular weight anionic surfactant may be selected from sodium dodecyl sulphate (SDS); potassium dodecyl sulphate, sodium laureth sulphate (SLES); sodium dodecylbenzenesulphonate; sodium cocoyl sarcosinate; sodium lauroyl sarcosinate. The low-molecular weight anionic surfactant is preferably selected from sodium dodecyl sulphate (SDS); sodium p-n-dodecylbenzenesulphonate; sodium cocoyl sarcosinate; and sodium lauroyl sarcosinate. More preferably the low-molecular weight anionic surfactant is sodium cocoyl sarcosinate. The anionic surfactant may be biodegradable.

The other one of the at least two surfactants is preferably a co-surfactant. The term “co-surfactant” as used herein refers to a surfactant that is complementary to another, primary, surfactant. The co-surfactant has properties that are different to those of the primary surfactant, so that the actions of the surfactants are complementing each other, thus improving the overall effectiveness of the surfactant system. A surfactant system may comprise more than one primary surfactant and also more than one co-surfactant.

A slow-acting co-surfactant may separate the charged surfactant head groups of the fast-acting surfactant that has settled at the air-water interphase, thus allowing for a tighter packing of the aliphatic carbon chains, and thereby improving the elastic modulus of the lipid layer formed at the air-water interphase. By introducing a co-surfactant, the water drainage half-life (t1/2) may also be improved, such as by a factor of 3 or more. A co-surfactant having a suitable pKa and a long carbon chain contributes to a stable fibre suspension and a stable wet foam. The co-surfactant may be selected from the group comprising surfactants having an apparent pka of at least 8, or at least 9, in a surfactant solution having pH of from 7 to 9, preferably having a pH of 8; and amphoteric betaines. The co-surfactant may have maximum apparent pKa of 10. The co-surfactant preferably has a long carbon chain, more preferably a carbon chain with 14 carbon atoms (C14). The co-surfactant may be selected from high pKa fatty acids, such as from plant derived feedstock, e.g. tetradecanoic acid (myristic acid), sodium oleate, lauric acid, palmitic acid, and stearic acid; glucose based co-surfactants with an aliphatic carbon tail, such as alkyl glycosides, alkylpolyglucosides, alkyl thio-glycosides, and alkyl maltosides; amphoteric betaines, such as cocamidopropyl betaine (CAPB), and sodium cocoiminodipropionate (CADP); polyethylene glycol sorbitan monolaurate, i.e. Tween® (e.g. Tween® 20, Tween® 80 and Tween® 85); and polyoxyethylene lauryl ethers, such as polyethylene glycol dodecyl ether, pentaethylene glycol monododecyl ether and octaethylene glycol monododecyl ether.

Thus, the at least two surfactants used in the foam composition preferably comprise a mixture of an anionic surfactant and a co-surfactant. The molar ratio between anionic surfactant to co-surfactant may be from 0.2:1-3:1, preferably from 0.5:1 to 2:1. The total amount of the at least two surfactants together in the foam composition may be 0.6-5 wt %, or 0.8-2.0 wt %, as calculated on the total weight of solid content of the foam. The surfactants may be added to the mixture obtained in step (b) as a solution, such as a solution comprising 3-25 wt %, preferably 5-20 wt %, of surfactants. The surfactant solution preferably has a pH of from 7 to 9, and more preferably a pH of 8. Preferably, the solution comprising the surfactants is an aqueous solution. More preferably, the solution is water. Alcohols may have a defoaming effect.

Cellulose fibres are 20-30 microns wide and therefore only bubbles that are sufficiently small, i.e. micron size, may suspend individual fibres thereby further improving the anti-flocculation properties of the foam. A water-soluble thickener and a slow-acting co-surfactant both contribute to a finer and more stable foam, which contributes to a lesser surface roughness of the dried foam. In a coarse foam, such as a foam containing large bubbles or having a large distribution of bubble size, the fibres tend to agglomerate leading to a high roughness of the surface. Upon aeration the composition comprising cellulose fibres, thickener and at least two surfactants according to the present invention will form a highly stable wet fibre foam. The aeration may be performed by mechanical agitation. A substantial amount of air is incorporated into the material upon aeration and the gas volume fraction, Ø, may be between 0.6 to 0.85. The formation of a foam will be promoted by the surfactants. Before aeration, the composition has a high viscosity and high yield stress, such as having the consistency of a non-flocculated paste.

By adjusting the stability of the wet foam with the use of thickeners and surfactant combinations, a free-standing cellulose foam can be made without the use of a cross-linker or fibrillated cellulose. A good stability of the foam prevents ripening, i.e. change in bubble size, and drainage. To form a free-standing cellulose foam, the apparent yield stress of the foam needs to exceed the stress exerted on the foam by gravity.

In the wet state the foam of the composition of the present invention may be considered to be a highly concentrated hydrocolloid suspension, which will flow if a mechanical load is applied. However, below the yield stress the foam will not flow. Thus, the wet foam prepared from the composition obtained in step d) is free-standing and does not require a mould or a forming fabric to retain its shape upon drying. The composition of the present invention can thus be foamed into a free-standing foam that is stable enough to be dried in the absence of a supporting mould without collapsing. As a result, objects can be formed and dried without the use of a mould.

The wet foam obtained in step d) may comprise 10-38 wt %, or 10-30 wt %, or 11-30 wt %, or 12-30 wt %, or 10-20 wt %, or 11-20 wt %, or 12-20 wt % cellulose fibres; 0.5-10 wt %, or 0.5-5 wt %, or 1-5 wt %, or 2-5 wt %, or 1-3 wt %, of a water-soluble thickener; and 0.1-2 wt % surfactants; as calculated on the total weight of the obtained fibre suspension. The wet foam obtained in step d) may be dried to obtain a dry cellulose foam. Because of the high solid content, the wet foam prepared from the composition according to the present invention does not need to be dewatered before it is dried. The foam may be dried by evaporation at room temperature or at an elevated temperature, such as a temperature of from 40-140° C. The dry cellulose foam may have a density of from 10-60 kg/m³. In one embodiment, the dry cellulose foam may have a density of from 10-80 kg/m³.

Use of a water-soluble thickener and a slow-acting co-surfactant enables evaporation of water from the fibrous foam without the collapse of its 3D-structure and avoids or delays the agglomeration of fibres. This contributes in large extent to a reduced roughness of the surface and thus enables a high-quality product after the drying consolidation step. Agglomeration of fibres may be delayed by controlling the rheological profile, such as the yield stress and viscosity, of the foam-particle dispersion. This involves adjusting parameters such as bubble size (R), gas volume fraction (Ø) and surface tension (γ). A good dispersion of the fibres in the wet-end of the method will thus contribute to reducing roughness of the surface when the foam is dried and providing a finer void structure in the cross-section of the product, with less density variations throughout the volume.

The wet foam can be dried into three-dimensional objects without constraints or shrinkage. Drying of the foam may be made using a two-step deposition, wherein a first deposition of the wet foam obtained in step d) is made as discrete units on a surface and drying the discrete units; a second preparation of a wet foam is prepared according to steps a) to d); a second deposition of the wet foam obtained in step d) is made by filling the wet foam between the discrete units of a dry cellulose foam of the first deposition; and drying the foam to obtain a solid foam comprising discrete units of a foam embedded in a foam matrix. In the initial drying stage of the discrete units, a densified fibre layer is formed on the surface of the foam. This crust-like layer provides mechanical support during drying helping to keep the shape of the discrete units.

The thickener may improve the fibre-fibre bonding strength, primarily through hydrogen bonding, in the dry foam, Therefore, the amount of thickener in the foam composition will influence the mechanical performance of the dried foam, and especially the bulk of the material. A higher content of thickener provides for a stiffer material. Thus, the thickener enables tailoring of the mechanical properties. The dried foam prepared from the composition according to the present invention, as well as the wet foam, can both be re-dispersed in water and as a result be recyclable in regular paper recycling streams.

A further aspect of the present invention is foam prepared with the method according to claim 13, wherein the foam has a density from 10-60 kg/m³.

The invention will now be described by the following examples which do not limit the invention in any respect. All cited documents and references mentioned herein are incorporated by reference in their entireties.

### EXAMPLES

### Materials

### Chemicals

Softwood bleached Kraft pulp, hardwood bleached Kraft pulp, dissolving pulp, carboxymethyl cellulose (Finnfix WRM from Nouryon, Finnfix30, Finnfix150, Finnfix300, Finnfix700 are from CP Kelco), sodium cocoyl sarcosinate, myristic acid, sodium N-lauroylsarcosinate (Crodasinic LS95NT from Croda)

### Example 1

### Different Amounts of Thickener

The effect of carboxymethyl cellulose (CMC) content on foam stability was investigated by studying samples prepared from different compositions as presented in Table 1.

Sample 1 was the most used composition in which the CMC content in dry foam is 10 wt %:

Softwood bleached Kraft pulp (120 g) was disintegrated in water (602 g) using a Kenwood Chef XL Titanium mixer equipped with the K beater, which produced a fibre suspension. CMC (13.5 g) was dissolved in water (256.5 g) using a Vitamixer so that a gel-like highly viscous solution was obtained. The gel was then added to the fibre suspension and mixed with the K beater until reaching a homogenous paste. Thereafter, a surfactant solution (20 wt %, 6 ml) containing 1:1 molar ratio of sodium cocoyl sarcosinate:myristic acid was added to the paste. The amount of total solid surfactant added was 1.2 g as shown in Table 1 corresponding to 0.9 wt % as calculated on the total weight of solid content of the composition. The paste was then aerated using the balloon whipper of a Kenwood mixer until the desired amount of air (78 vol % of the total volume of the foam) was mechanically introduced to the mixture and a wet foam density of ˜222 kg/m³ was obtained.

A solid foam was prepared by the following two-step deposition method:

In a first deposition step, cylindrical moulds with a diameter of 6.7 cm and a height of 5.2 cm were used for a first deposit of the prepared wet foam in 12 discrete units on a flat perforated oven tray (perforation diameter 3 mm) with a frame of 27×37×5 cm. The moulds were only used to deposit the foam in the specific shape and dimension and were removed before drying of the foam. The discrete units were then dried in an ordinary convection oven at 120° C. for 1-2 hours. The wet foam prepared this way showed high stability so that the deposited shape and height was kept even when the moulds were removed as well as during the drying. This was followed by the second deposition step for which a new batch of foam was prepared in the same way as the foam used in the first deposition. The space between the dried discrete units was filled with the new wet foam, completely filling the oven frame leaving out no voids. The surface was then scraped to remove any extra foam and levelling out the surface to the height of the frame. The foam was finally dried in the oven at 120° C. for 8 hours. The density of the dried discrete units as well as the density of the final foam plank was ˜30 kg/m³. The thickness of the final foam plank was ˜5 cm.

For samples 2, 3 and 4 the amount of used CMC was varied according to Table 1 so that the CMC content in dry foam was 5 wt %, 15 wt % or 20 wt %, respectively, as calculated on the total weight of solid content of the composition. The surfactant content in the dry foam for all samples was kept to 0.9 wt %, as calculated on the total weight of solid content of the composition. The solid content in the wet foam was kept to 13.5 wt %, as calculated on the total weight of the wet composition, as shown in Table 1 for all the samples. Similar to Sample 1, Samples 2, 3 and 4 were also prepared according to the 2-step deposition procedure described above and for each formulation the wet stability of foam was high enough allowing the discrete units to be dried without a mould and keeping the initial shape during drying.

TABLE 1

| Sample no.: | 1 | 2 | 3 | 4 |
|---|---|---|---|---|
| Cellulose fibres (g) | 120 | 120 | 120 | 120 |
| Water added to | 602 | 691 | 502 | 391 |
| fibres (g) | | | | |
| Thickener (g) | 13.5 | 6.4 | 21.4 | 30.3 |
| Surfactant (g) | 1.2 | 1.2 | 1.3 | 1.4 |
| Total water (g) | 863 | 817 | 914 | 972 |
| Solid content in wet | 13.5 | 13.5 | 13.5 | 13.5 |
| foam (wt %) | | | | |
| Air content in foam | 78 | 78 | 78 | 78 |
| (vol %) | | | | |
| Wet foam density | ~222 | ~222 | ~222 | ~222 |
| (kg/m³) | | | | |
| Stability of wet foam | stable | rather stable | stable | highly stable |
| Dry foam density | ~30 | ~30 | ~30 | ~30 |
| (kg/m³) | | | | |

### Example 2

### Different Molar Ratios of the Main and Co-Surfactants

The effect of the molar ratio of main surfactant, sodium cocoyl sarcosinate to the co-surfactant myristic acid was investigated by studying recipes presented in Table 2. Sample 2 was the most used recipe in which the molar ratio of sodium cocoyl sarcosinate to myristic acid was 1:1:

Softwood bleached Kraft pulp (120 g) was disintegrated in water (602 g) using a Kenwood Chef XL Titanium mixer equipped with the K beater, which produced a fibre suspension. CMC (13.5 g) was dissolved in water (256.5 g) using a Vitamixer so that a gel-like highly viscous solution was obtained. The gel was then added to the fibre suspension and mixed with the K beater until reaching a homogenous paste. Thereafter surfactant solution (20 wt %, 6 ml) containing 1:1 molar ratio of sodium cocoyl sarcosinate:myristic acid was added to the paste. The amount of total solid surfactant added was 1.2 g as shown in Table 2 corresponding to 0.9 wt % as calculated on the total weight of solid content of the foam. The paste was then aerated using the balloon whipper of Kenwood mixer until the desired amount of air (78 vol % of the total volume of the foam) was mechanically introduced to the mixture and a wet foam density of ˜222 kg/m³ was obtained.

The wet foam was used for preparing a solid foam plank according to the two-step deposition method described in Example 1.

The wet foam in the first deposition showed high stability so that the shape and height of the discrete units in the first deposition was kept even when the moulds were removed, as well as during the drying. In the second deposition a new batch of foam was prepared according to the above description of the foam used in the first deposition. The density of the dried discrete units as well as the density of the final foam plank was ˜30 kg/m³. The thickness of the final foam plank was ˜5 cm.

For Samples 1 and 3, the molar ratio of sodium cocoyl sarcosinate:myristic acid was changed according to Table 2. The total surfactant content for all samples was kept to 0.9 wt %, as calculated on the total weight of solid content of the composition. The total solid content of the wet foam was kept to 13.5 wt %, as calculated on the total weight of the wet composition, for all the samples in this example. Similar to Sample 2, Samples 1 and 3 were also prepared according to the two-step deposition procedure described above. Each formulation showed high wet foam stability allowing the discrete units to be dried without a mould and keeping the initial shape during drying.

TABLE 2

| Sample: | 1 | 2 | 3 |
|---|---|---|---|
| Cellulose fibres (g) | 120 | 120 | 120 |
| Water added to fibres | 602 | 602 | 602 |
| (g) | | | |
| Thickener (g) | 13.5 | 13.5 | 13.5 |
| Surfactant (g) | 1.2 | 1.2 | 1.2 |
| sodium cocoyl | 0.5:1 | 1:1 | 2:1 |
| sarcosinate:myristic | | | |
| acid molar ratio | | | |
| Total water (g) | 863 | 863 | 863 |
| Solid content in wet | 13.5 | 13.5 | 13.5 |
| foam (wt %) | | | |
| Air content in foam | 78 | 78 | 78 |
| (vol %) | | | |
| Stability of wet foam | highly stable | highly stable | stable |
| Dry foam density | ~30 | ~30 | ~30 |
| (kg/m³) | | | |

### Example 3

### Different Sources of Cellulose Fibres

The effect of the type of cellulose fibres was investigated by studying recipes presented in Table 3. Three different foams were prepared by using either softwood bleached Kraft pulp, hardwood bleached Kraft pulp or dissolving pulp. For each of the three samples the foam was prepared according to Sample 2 described in Example 2. Each of the three different foams was prepared according to the two-step deposition method described in Example 1 for preparing a solid foam plank. The wet foam prepared using each of reported fibre sources was highly stable so that the discrete units deposited during the first step could be dried without using a mould while they kept their shape during drying. The density of the dried discrete units as well as the density of the final dry foam plank for Sample 1, 2 and 3 was ˜30 kg/m³. The thickness of the final foam plank for Sample 1 and 3 was 5 cm. The thickness of the final foam plank for Sample 2 was 2.5 cm.

TABLE 3

| Sample no.: | 1 | 2 | 3 |
|---|---|---|---|
| Cellulose fibre | Softwood | Hardwood | Dissolving pulp |
| source | | | |
| Cellulose fibres (g) | 120 | 120 | 120 |
| Water added to | 602 | 602 | 602 |
| fibres (g) | | | |
| Thickener (g) | 13.5 | 13.5 | 13.5 |
| Surfactant (g) | 1.2 | 1.2 | 1.2 |
| Total water (g) | 863 | 863 | 863 |
| Solid content in | 13.5 | 13.5 | 13.5 |
| wet foam (wt %) | | | |
| Stability of wet | highly stable | stable | highly stable |
| foam | | | |
| Dry foam thickness | 5 | 2.5 | 5 |
| (cm) | | | |
| Dry foam density | ~30 | ~30 | ~30 |
| (kg/m³) | | | |

### Example 4

### Different Densities

Cellulose fibres (120 g, softwood bleached Kraft pulp fibres) were disintegrated in of water (602 g) using a Kenwood Chef XL Titanium mixer equipped with the K beater. CMC (13.5 g) was dissolved in water (256.5 g) using a Vitamixer and a gel-like highly viscous solution was obtained. The CMC gel was then added to the cellulose fibre suspension and mixed with the K beater until reaching a homogenous mixture. Thereafter, a surfactant solution (20 wt %, 6 ml) containing 1:1 molar ratio of sodium cocoyl sarcosinate:myristic acid was added to the cellulose fibre/CMC solution mixture. The amount of total solid surfactant added was 1.2 g as shown in Table 4 corresponding to 0.9 wt % as calculated on the total weight of solid content of the composition. The mixture was then aerated using the balloon whipper of Kenwood mixer until the desired amount of air was mechanically introduced to the mixture (see Table 4). The wet foam was used for preparing a solid foam plank according to the two-step deposition method described in Example 1. The wet foams prepared this way showed high stability so that the shape of the discrete units and height was kept even when the moulds were removed after the first deposition, as well as during the drying of the first deposition. For the second step deposition a new batch of foam was prepared according to the above description of the foam used in the first deposition. The density of the dry foam calculated for specific volume increase (i.e. air content in foam in volume % of the total volume of the foam) can be seen in Table 4. The time required to reach low wet densities of foam (i.e. low dry densities) is longer compared to the time to reach high densities of foam.

For Samples 1, 2, 3 and 4, the total surfactant content was kept to 0.9 wt %, as calculated on the total weight of solid content of the composition. The solid content (conc.) of wet foam was kept to 13.5 wt %, as calculated on the total weight of the wet composition. for all the samples in this example. All samples were prepared according to the 2-step deposition procedure described above. Each formulation showed high wet foam stability allowing the discrete units to be dried without a mould and keeping the initial shape during drying.

TABLE 4

| Sample no: | 1 | 2 | 3 | 4 |
|---|---|---|---|---|
| Cellulose fibres (g) | 120 | 120 | 120 | 120 |
| Water added to | 602 | 602 | 602 | 602 |
| fibres (g) | | | | |
| Thickener (g) | 13.5 | 13.5 | 13.5 | 13.5 |
| Surfactant (g) | 1.2 | 1.2 | 1.2 | 1.2 |
| Total water (g) | 863 | 863 | 863 | 863 |
| Solid content in wet | 13.5 | 13.5 | 13.5 | 13.5 |
| foam (wt %) | | | | |
| Air content in foam | 85 | 78 | 70 | 63 |
| (vol %) | | | | |
| Volume increase | 675 | 450 | 338 | 270 |
| (%) | | | | |
| Wet foam density | 148 | 222 | 296 | 370 |
| (kg/m³) | | | | |
| Dry foam density | ~20 | ~30 | ~40 | ~50 |
| (kg/m³) | | | | |

### Example 5

### Different Molecular Weight of Thickeners

Cellulose fibres (softwood bleached Kraft pulp fibres, 120 g) were disintegrated in water (691 g) using a Kenwood Chef XL Titanium mixer equipped with the K beater, which produced a fibre suspension. Different molecular weights of CMC (Finnfix 30, Finnfix 150, Finnfix 300, and Finnfix 700 from CP Kelco) (6.4 g) were dissolved in water (121.2 g) using a Vitamixer and a gel-like highly viscous CMC solutions were obtained. The CMC gel was then added to the cellulose fibre suspension and mixed with the K beater until reaching a homogenous mixture. Thereafter a surfactant solution (20 wt %, 6 ml) containing 1:1 molar ratio of sodium cocoyl sarcosinate:myristic acid was added to the cellulose fibre/CMC solution mixture. The amount of total solid surfactant added was 1.2 g as shown in Table 5 corresponding to 0.9% of dry foam content. The mixture was then aerated using the balloon whipper of Kenwood mixer until the desired amount of air (78 vol % of the total volume of the foam) was mechanically introduced to the mixture and a wet foam density of ˜222 kg/m³ was obtained. The wet foam was used for preparing a solid foam plank according to the two-step deposition method described in Example 1. The wet foam prepared this way showed high stability so that the deposited shape and height was kept even when the moulds were removed as well as during the drying. In the second deposition a new batch of wet foam was prepared according to the above description of the wet foam used in the first deposition.

For Samples 1, 2, 3 and 4, the total surfactant content in dry foam was kept to 0.9% and the dry content (conc.) of wet foam was kept to 13.5% for all the samples in this example. All samples were prepared according to the two-step deposition procedure described above. Each formulation showed high wet foam stability allowing the discrete units to be dried without a mould and keeping the initial shape during drying. The viscosity of the thickener increases as the molecular weight of the thickener increases for the same concentration of the solution. The wet foam stability shows a positive trend when the foam is prepared using a high molecular weight thickener at the same concentration, but the time required to increase the volume of the foam (i.e. time to reach the same wet foam density) is longer for the foams that are prepared using the thickeners having higher molecular weight. The stability of the wet foam shows a correlation with the mechanical strength of the dry foam.

TABLE 5

| Sample no: | 1 | 2 | 3 | 4 |
|---|---|---|---|---|
| Cellulose fibres (g) | 120 | 120 | 120 | 120 |
| Water added to | 691 | 691 | 691 | 691 |
| fibres (g) | | | | |
| Thickener (g) | 6.4 | 6.4 | 6.4 | 6.4 |
| Thickener | 83000 | 116000 | 151000 | 197000 |
| molecular weight | | | | |
| (g/mol) | | | | |
| Surfactant (g) | 1.2 | 1.2 | 1.2 | 1.2 |
| Total water (g) | 817 | 817 | 817 | 817 |
| Air content in foam | 78 | 78 | 78 | 78 |
| (vol %) | | | | |
| Wet foam density | ~222 | ~222 | ~222 | ~222 |
| (kg/m³) | | | | |
| Stability of wet | Stable | Rather stable | Very stable | Highly stable |
| foam | | | | |
| Dry foam density | ~30 | ~30 | ~30 | ~30 |
| (kg/m³) | | | | |

### Example 6

### Comparative Example: Using Sodium Lauroyl Sarcosinate as the Foaming Agent

As a comparison to the combination of sodium cocoyl sarcosinate and myristic acid, sodium N-lauroyl sarcosinate (LS95NT from Croda) was used as a single surfactant and the effect on wet foam stability was studied. The recipe used in this case was similar to what described for Sample 2 in Example 2, just that instead of sodium cocoyl sarcosinate-myristic acid solution, LS95NT solution with same concentration was used as the foaming agent:

Softwood bleached Kraft pulp (120 g) was disintegrated in water (602 g) using a Kenwood Chef XL Titanium mixer equipped with the K beater, which produced a fibre suspension. Carboxymethyl cellulose (CMC) (13.5 g) was dissolved in water (256.5 g) using a Vitamixer so that a gel-like highly viscous solution was obtained. The gel was then added to the fibre suspension and mixed with the K beater until reaching a homogenous paste. Thereafter a surfactant solution (20 wt %, 6 ml) containing only LS95NT was added to the paste so that the amount of solid surfactant added was 1.2 g.

The paste was then aerated using the balloon whipper of Kenwood mixer until reaching a wet density of ˜222 kg/m³. Already at this phase the difference compared to the wet foam prepared with sodium cocoyl sarcosinate-myristic acid could be clearly observed. Although it took less time to reach the desired amount of foaming and volume increase, the resulting wet foam looked less stable and creamy with smaller air bubbles coalescing to larger ones as soon as the wet foam was transferred from the Kenwood bowl to the oven tray and was spread out. With continuous bursting of air bubbles, the wet foam was not stable enough neither at room temperature when being deposited into the moulds nor when drying. This caused collapse and shrinkage during drying and a rough final surface. The formulation was therefore not considered suitable for either a single or two-step deposition technique.

### Example 7

### Comparative Example: Using Low and High Amount of Thickener

Cellulose fibres (softwood bleached Kraft pulp fibres, 120 g) were disintegrated in water (733 g) using a Kenwood Chef XL Titanium mixer equipped with the K beater, which produced a cellulose fibre suspension. CMC (Finnfix WRM from Nouryon, 3.1 g) was dissolved in water (59 g) using a Vitamixer and a gel-like highly viscous CMC solution was obtained. The CMC gel was then added to the cellulose fibre suspension and mixed with the K beater until reaching a homogenous mixture. Thereafter a surfactant solution (20 wt %, 6 ml) containing 1:1 molar ratio of sodium cocoyl sarcosinate:myristic acid was added to the cellulose fibre/CMC solution mixture. The amount of total solid surfactant added was 1.2 g as shown in Table 6 corresponding to 0.9% of dry foam content. The mixture was then aerated using the balloon whipper of Kenwood mixer until the desired amount of air (78%) was mechanically introduced to the mixture and a wet foam density of ˜222 kg/m³ was obtained. The time required to reach the target density (i.e. foam air content) was shorter compared to samples prepared in Example 1 but the wet foam showed low stability compared to foams that are prepared in Example 1. The aerated mixture was then transferred to cylindrical moulds with a diameter of 6.7 cm and a height of 5.2 cm to deposit the prepared foam in 12 discrete units on a flat perforated oven tray (perforation diameter 3 mm) with a frame of 27×37×5 cm. The moulds were only used to deposit the foam in the specific shape and dimension and were removed before drying of the foam. The wet foam had lower viscosity and unstable texture which as a result caused a collapse of the foam after removing the moulds. The discrete units of foam formed using moulds were slowly deteriorated. The discrete units were then dried in an ordinary convection oven at 120° C. for 1-2 hours. The wet foam shrank during drying. The dry foam had lower mechanical strength compared to the foams prepared in Example 1.

Cellulose fibres (softwood bleached Kraft pulp fibres, 120 g) were disintegrated in water (328 g) using a Kenwood Chef XL Titanium mixer equipped with the K beater, which produced a cellulose fibre suspension. CMC (Finnfix WRM from Nouryon, 35.2 g) was dissolved in water (669.7 g) using a Vitamixer and a gel-like highly viscous CMC solution was obtained. The CMC gel was then added to the cellulose fibre suspension and mixed with the K beater until reaching a homogenous mixture. Thereafter a surfactant solution (20 wt %, 6 ml) containing 1:1 molar ratio of sodium cocoyl sarcosinate:myristic acid was added to the cellulose fibre/CMC solution mixture. The amount of total solid surfactant added was 1.2 g as shown in Table 6 corresponding to 0.9 wt % as calculated on the total weight the solid content of the composition. The mixture was then aerated using the balloon whipper of Kenwood mixer until the desired amount of air (78%) was mechanically introduced to the mixture and a wet foam density of ˜222 kg/m³ was obtained. The time required to reach the target density (i.e. foam air content) was longer compared to samples prepared in Example 1 and the wet foam showed low stability and cellulose fibre bundles could be identified compared to foams that are prepared in Example 1. The aerated mixture was then transferred to cylindrical moulds with a diameter of 6.7 cm and a height of 5.2 cm to deposit the prepared foam in 12 discrete units on a flat perforated oven tray (perforation diameter 3 mm) with a frame of 27×37×5 cm. The moulds were only used to deposit the foam in the specific shape and dimension and were removed before drying of the foam. The wet foam had unstable texture which as a result caused a collapse of the foam. The discrete units of foam formed using moulds were slowly deteriorated. The discrete units were then dried in an ordinary convection oven at 120° C. for 1-2 hours. The wet foam shrank during drying.

For Samples 1 and 2, the total surfactant content in dry foam was kept to 0.9% and the dry content (conc.) of wet foam was kept to 13.5 wt % as calculated on the total weight of the wet composition for all the samples in this example. All samples were prepared according to the 2-step deposition procedure described above. Each formulation showed low wet foam stability not allowing the discrete units to be dried without a mould and it was not possible to keep the initial shape during drying. The wet foam stability showed a negative trend when the foam was prepared using either a low (i.e. 2.5 wt %) or high (i.e. 22.5 wt %) CMC content, as calculated on the total weight of solid content of the composition. The increase in CMC content caused an increase in stiffness of the foam after drying. The increase in CMC content also reduced the recyclability of the foam after drying.

TABLE 6

| Sample: | 1 | 2 |
|---|---|---|
| Cellulose fibres (g) | 120 | 120 |
| Water added to fibres (g) | 733 | 328 |
| Thickener (g) | 3.1 | 35.2 |
| Surfactant (g) | 1.2 | 1.2 |
| Total water (g) | 796 | 1004 |
| Air content in foam (vol %) | 78 | 78 |
| Wet foam density (kg/m³) | ~222 | ~222 |
| Stability of wet foam | Unstable | Stable |
| Dry foam density (kg/m³) | ~30 | ~30 |

### Example 8

### Evaluation of Yield Stress of Wet Foam in Relation to Solid Content of Slurry

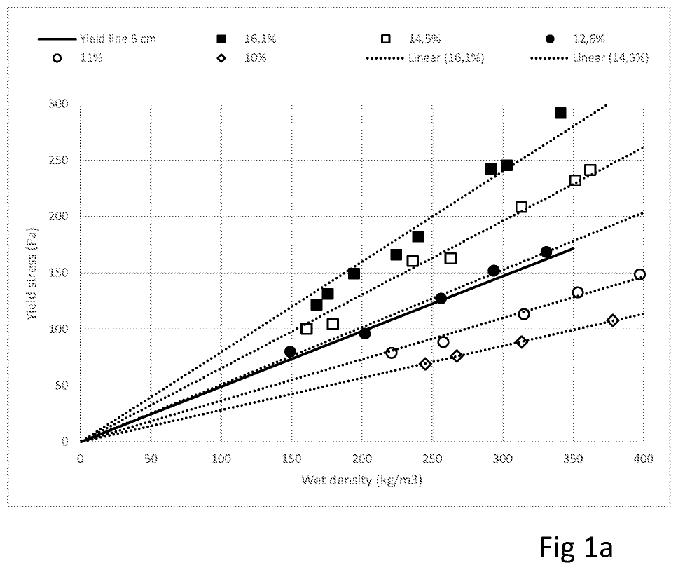

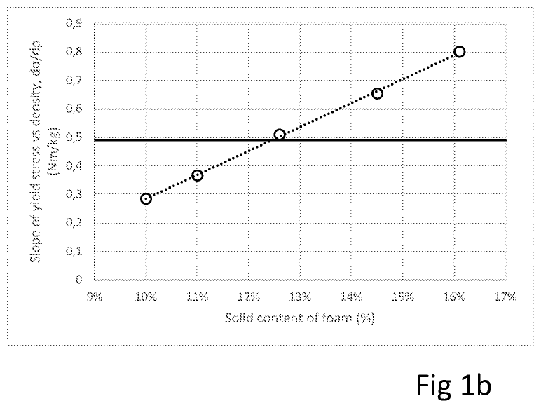

In order to evaluate the influence of the solid content of the foam on the yield stress, wet foam compositions with different solid contents (10%, 11%, 12.6%, 14.5% and 16.1%) were prepared. The foam compositions all comprised 10% CMC, 1% surfactants and 89% cellulose fibres, based on the total weight of the solid content of the foam composition. The overall solid content was adjusted by the amount of water added (see table 7). Cellulose fibres (120 g, softwood bleached Kraft pulp fibres) were disintegrated in water (see table 7 for amounts of water added) using a Kenwood Chef XL Titanium mixer equipped with the K beater. For solid contents of 14.5% and 16.1%, water was squeezed out after pulping with 600 ml water to achieve the above-mentioned solid contents after addition of thickener. CMC (13.5 g) was dissolved in water (256.5 g) using a Vitamixer and a gel-like highly viscous solution was obtained. The CMC gel was then added to the dewatered cellulose fibre suspension and mixed with the K beater until reaching a homogenous mixture. Thereafter, a surfactant solution (20 wt %) containing 1:1 molar ratio of sodium cocoyl sarcosinate:myristic acid was added portion wise (0.5 ml) to the cellulose fibre/CMC solution mixture. The mixture was then aerated using the balloon whipper of Kenwood mixer until the desired amount of air was mechanically introduced to the mixture. After mixing, foam was collected in a 250 ml plastic cup and the yield stress was measured using a Brookfield DVNext, using vane spindles V73 and V72 at 0.5 RPM, and the built-in yield stress test. Results are shown in FIGS. 1a-b. The solid line in FIGS. 1a-b represents the yield line, i.e. the gravitational stress, for a 5 cm thick foam. Below the yield line, the wet foam will behave like a viscous liquid given enough stress and is expected to cause sagging at the bottom. While above the yield line the wet foam will instead behave like a solid. From FIG. 1a it is evident that the wet foams having a solid content of 10 and 11% are below the yield line, whereas the wet foams having a solid content of 12.6%, 14.5% or 16.1% are all above the yield line. FIG. 1b shows the linear slope of the curves in FIG. 1a as a function of the solid content in the wet foam. The relationship between change in yield stress and solid content is linear. Thus, the transition from liquid to solid behaviour occurs at a solid content of about 12.5% for a wet foam composition comprising softwood kraft pulp.

TABLE 7

| Solid content (%) | Amount of water (ml) |
|---|---|
| 10 | 850 |
| 11 | 730 |
| 12.6 | 600 |
| 14.5 | 470 |
| 16.1 | 350 |

1. A foam composition comprising:
a) from 71-95 wt % cellulose fibers, as calculated on a total weight of solid content of the foam composition,
b) from 4-24 wt % of a water-soluble thickener, as calculated on the total weight of solid content of the foam composition, and
c) at least two surfactants.

2. The foam composition according to claim 1, wherein one of the at least two surfactants is an anionic surfactant having an apparent pKa of from 3.2 to 3.8 in a solution having a pH of from 7 to 9.

3. The foam composition according to claim 1, wherein one of the at least two surfactants is a co-surfactant.

4. The foam composition according to claim 3, wherein the co-surfactant is selected from a group consisting of: surfactants having an apparent pKa of at least 8 in a solution having a pH of from 7 to 9; and amphoteric betaines.

5. The foam composition according to claim 3, wherein a molar ratio between an anionic surfactant to co-surfactant is from 0.2:1-3:1.

6. The foam composition according to claim 1, wherein a total amount of the at least two surfactants is 0.6-5 wt %, as calculated on the total weight of solid content of the foam composition.

7. The foam composition according to claim 1, wherein the cellulose fibers are selected from a group consisting of: wood pulp; regenerated cellulose fibers; and plant fibers.

8. The foam composition according to claim 1, which is a wet foam composition having a total solid content from 12-40 wt % as calculated on the total weight of the wet foam composition.

9. The foam composition according to claim 8, having a density from 140-500 kg/m³.

10. The foam composition according to claim 8, having a yield stress of at least 80 Pa.

11. The foam composition according to claim 1, which has a density from 10-60 kg/m³.

12. A method for the preparation of a foam composition, the method comprising:
a) disintegrating cellulose fibers in water to obtain a slurry of cellulose fibers;
b) adding a water-soluble thickener to the slurry obtained in a) to obtain a mixture of water-soluble thickener and cellulose fibers in water;
c) adding at least two surfactants to the mixture obtained in b) to obtain a fiber suspension;
d) aerating the suspension obtained in c) to obtain a wet foam,
wherein the wet foam comprises 10-38 wt % cellulose fibers, 0.5-10 wt % of the water-soluble thickener, and 0.1-2 wt % surfactants, as calculated on a total weight of the wet foam, and
wherein the wet foam has a density of from 140-500 kg/m³ and a yield stress of at least 80 Pa.

13. The method according to claim 12, further comprising drying the wet foam obtained in d) to obtain a dried cellulose foam.

14. The method according to claim 12, wherein the water-soluble thickener is added to the slurry obtained in step (a) as a solution comprising 4-12 wt % of the water-soluble thickener.

15. A foam obtained with the method according to claim 12.

16. A foam prepared with the method according to claim 13, wherein the foam has a density from 10-60 kg/m³.
